(19) United States
(12) Patent Application Publication
(10) Pub. No.: US 2024/0417256 A1
(43) Pub. Date: Dec. 19, 2024

(54) PRODUCTION OF SULFURIC ACID EMPLOYING AN O2 RICH STREAM

(71) Applicant: Topsoe A/S, Kgs. Lyngby (DK)

(72) Inventors: Mårten Nils Rickard GRANROTH, Bunkeflostrand (SE); Per Aggerholm SØRENSEN, Kgs. Lyngby (DK); James Bernard ROSENFELDT, Mount Pleasant (AU)

(73) Assignee: Topsoe A/S, Kgs. Lyngby (DK)

(21) Appl. No.: 18/699,553

(22) PCT Filed: Oct. 28, 2022
(86) PCT No.: PCT/EP2022/080166

§ 371 Date: Apr. 8, 2024

(30) Foreign Application Priority Data
Oct. 28, 2021 (EP) 21205190.8

(51) Int. Cl. C01B 17/79; B01J 21/08; B01J 27/055; C01B 17/80; C01C 1/04; C01C 1/242; C05B 7/00; C05C 3/00

(52) U.S. Cl. CPC C01B 17/79; B01J 21/08; B01J 27/055; C01B 17/80; C01C 1/04; C01C 1/242; C05B 7/00; C05C 3/00

(57) ABSTRACT

A process and a process plant for conversion of SO₂ to H₂SO₄ including a. directing a process gas stream including at least 15 vol % SO₂, and an amount of O₂ originating from a source of purified O₂ or O₂ enriched air to contact a first material catalytically active in oxidation of SO₂ to SO₃ under oxidation conditions involving a maximum steady state temperature of the catalytically active material above 700° C., to provide an oxidized process gas stream, wherein the material catalytically active in oxidation of SO₂ to SO₃ includes an active phase in which the weight ration of vanadium to other metals is at least 2:1 supported on a porous carrier comprising at least 25 wt % crystalline silica, b. absorbing at least an amount of the produced SO₃ in a stream of lean sulfuric acid to provide a stream of liquid sulfuric acid.

The present invention relates to a process for production of sulfuric acid using an amount of O₂ enriched gas, a process for co-production of sulfuric acid and other chemicals, especially ammonia and process plants for such processes.

The abundance of nitrogen in atmospheric air may result in excessive process equipment size for processes involving oxidation with atmospheric air as oxidant, as the inert nitrogen will require additional process volume, which is related to increased costs of equipment. At the same time the additional process volume also has the benefit of providing a heat sink for exothermal reactions, which may keep the temperature in a desirable range. While oxygen enriched air or pure oxygen has been used in select cases. commonly the cost of O₂ is too high to be a commercially viable path for reduction of process equipment size. Furthermore, the high amount of heat released during the oxidation process will lead to excessive process temperatures, which commonly also is a problem requiring a solution.

We have now identified that the in a hydrogen-based society, the production of H₂ by electrolysis and the use of NH₃ as an energy vector will both provide an increased availability of O₂ and O₂ enriched gas at moderate cost, which motivates identifying beneficial application of O₂ enriched gas. In sulfuric acid production, choosing a catalytically active material which is active at elevated temperatures, such O₂ enriched gas may be used in the SO₂ oxidation process, together with O₂ from electrolytic sources or O₂ from air separation for NH₃ production.

In the following the term lean sulfuric acid shall be understood as sulfuric acid having the ability to absorb SO₃, and not imply an explicit concentration of H₂SO₄.

In the following the term concentrated sulfuric acid shall be understood as any sulfuric acid having absorbed SO₃ which depending on the conditions may be either below the concentrations matching trade definitions of concentrated sulfuric acid or be oleum, and thus not imply an explicit concentration of H₂SO₄.

In the following the unit Nm³ shall be understood as “normal” m³, i.e. the amount of gas taken up this volume at 0° C. and 1 atmosphere.

Where concentrations are stated in vol % this shall be understood as volumetric % (i.e. molar percentages for gases).

Streams may in the following be designated by a reaction, e.g. an oxidized process gas stream. Such terminology shall not be construed as a limitation to completely reacted streams, but merely as an identification of the stream for referencing.

A first aspect of the disclosure relates to a process for conversion of SO₂ to H₂SO₄ comprising the steps of
a. directing a process gas stream comprising at least 15 vol % SO₂, such as at least 20 vol %, such as at least 24 vol % or at least 30 vol %, and an amount of O₂ originating from a source of purified O₂ or O₂ enriched air to contact a material catalytically active in oxidation of SO₂ to SO₃ under oxidation conditions involving a maximum steady state temperature of the catalytically active material above 700° C. or 750° C., to provide an oxidized process gas stream,
b. absorbing at least an amount of the produced SO₃ in a stream of lean sulfuric acid to provide a stream of liquid sulfuric acid and optionally a desulfurized process gas stream.

Preferably said material catalytically active in oxidation of SO₂ to SO₃ comprises an active phase in which the weight ration of vanadium to other metals is at least 2:1 supported on a porous carrier comprising at least 25 wt % crystalline silica.

This has the associated benefit of such a process having a lower process volume compared to a similar process employing atmospheric air, and a potential for a process. The metals in the catalytically active material will mainly be vanadium and alkali metals, whereas other metals, including iron, are generally only present in trace amounts.

A second aspect of the disclosure relates to a process according to the first aspect further comprising the step of recycling an amount of oxidized process gas or desulfurized process gas to contact said first material catalytically active in oxidation of SO₂ to SO₃. This has the associated benefit of enabling temperature moderation by providing a heat sink by the recycled process gas.

A third aspect of the disclosure relates to a process according to an aspect above, wherein oxidation conditions involve a pressure above 2 Barg, 5 Barg or 10 Barg. This has the associated benefit of reducing the gas volume and thus the required volume and cost of process equipment.

A fourth aspect of the disclosure relates to a process according to an aspect above wherein oxidation conditions involve a pressure below 100 Barg, 50 Barg or 20 Barg. This has the associated benefit of operation at a pressure matching ammonia and methanol production while avoiding excessive demands and cost of process equipment.

A fifth aspect of the disclosure relates to a process according to an aspect above, wherein less than 100 Nm³ process gas per ton sulfuric acid produced, such as 50 Nm³/t or 10 Nm³/t is released to the atmosphere.

This has the associated benefit of minimizing the stack size and the perceived environmental impact.

A sixth aspect of the disclosure relates to a process according to an aspect above, wherein the first material catalytically active in oxidation of SO₂ to SO₃ is characterized by comprising vanadium pentoxide (V₂O₅), sulfur in the form of sulfate, pyrosulfate, tri- or tetrasulfate, one or more alkali metals on a porous carrier comprising at least 50 wt % crystalline silica. This has the associated benefit of such a material being stable and catalytically active at elevated temperatures.

A seventh aspect of the disclosure relates to a process according to an aspect above wherein an amount of the process gas stream is provided from an O₂ enriched gas stream comprising at least 50 vol % O₂, such as at least 90 vol % O₂, or at least 95 vol % O₂. This has the associated benefit of providing a gas stream with an amount of O₂ with reduced volume compared to atmospheric air with 21% O₂.

An eighth aspect of the disclosure relates to a process according to an aspect above further comprising the step of directing an amount of elemental sulfur and the O₂ enriched gas stream to a sulfur incinerator, to provide said process gas comprising SO₂. This has the associated benefit of providing SO₂ and heat from the elemental sulfur.

A ninth aspect of the disclosure relates to a process according to an aspect above wherein an amount of the O₂ is provided by electrolysis of H₂O. This has the associated benefit of the O₂ enriched gas stream being provided as a side stream at moderate costs from hydrogen production.

A tenth aspect of the disclosure relates to a process according to the ninth aspect above wherein electrolysis of H₂O is carried out in a process at a temperature above 400° C., such as a solid oxide electrolysis process. This has the associated benefit of the heat integration by transferring heat from sulfuric acid production to electrolysis is beneficial.

An eleventh aspect of the disclosure relates to a process according to an aspect above, wherein said process gas stream comprising at least 15 vol % SO₂, originates from incineration of sulfur or sulfur recuperation from smelter operation. This has the associated benefit of efficiently providing a rich SO₂ stream from a stable source.

A twelfth aspect of the disclosure relates to a process according to an aspect above wherein at least an amount of the O₂ enriched gas stream is provided by separation of atmospheric air. This has the associated benefit the O₂ enriched gas stream being provided as a side stream at moderate cost from air separation, e.g. in NH₃ production.

A thirteenth aspect of the disclosure relates to a process for co-production of NH₃ and H₂SO₄ involving a process for production of H₂SO₄ according to the twelfth aspect where the separation of atmospheric air further provides an N₂ enriched gas stream which is directed to a plant for production of NH₃, said process optionally involving the production of ammonium sulfate from NH₃ and H₂SO₄.

This has the associated benefit of integration between the NH₃ production process providing a stream of O₂ enriched gas and a the H₂SO₄ production process consuming such a stream.

A fourteenth aspect of the disclosure relates to a process according to the thirteenth aspect wherein heat is released during oxidation of SO₂ to SO₃ and directed to be used in NH₃ production. This has the associated benefit of reducing the cost of the energy intensive NH₃ production process, by provision of energy to the NH₃ production. The value of heat is typically higher, the higher the pressure or temperature steam.

A fifteenth aspect of the disclosure relates to a process for production of fertilizer comprising ammonium and phosphate, comprising a process for co-production of NH₃ and H₂SO₄ according to the thirteenth or fourteenth aspect and the process of producing phosphate from a phosphor source, employing the produced H₂SO₄. This has the associated benefit of reducing the cost of the process by integration of the sub-processes.

A process plant for production of H₂SO₄ comprising a means for production of an O₂ enriched stream having an O₂ enriched stream outlet, an optional sulfur incinerator having at least one inlet and an outlet, a reactor containing a material catalytically active in SO₂ oxidation at temperatures above 700° C. having an inlet and an outlet in fluid communication with the gas inlet of an absorber, having a liquid inlet for lean sulfuric acid, a liquid outlet for withdrawal of concentrated sulfuric acid and a gas outlet, characterized in the O₂ enriched stream outlet being in fluid communication with the inlet of the reactor, or if the optional sulfur incinerator is present, with an inlet to the sulfur incinerator, having the outlet in fluid communication with the inlet of the reactor. This has the associated benefit of enabling a process with reduced process volume, due to the use of O₂ enriched gas.

Sulfuric acid is the most abundantly produced chemical worldwide. One common process for production of sulfuric acid is known as the dry gas method. In general, for this process, elemental sulfur is combusted to form SO₂ which is catalytically oxidized to SO₃. The SO₃ in the process gas is converted to concentrated sulfuric acid by absorption in lean sulfuric acid.

The combustion of sulfur and the catalytic oxidation of SO₂ both require oxygen, typically supplied in the form of atmospheric air. However, if atmospheric air, containing inert N₂, is used, a large amount of flue gas is released from the process. A typical dry gas sulfuric acid plant will release 1700 Nm³ flue gas/ton sulfuric acid produced. The flue gas will contain low levels of compounds of environmental concern, but will still be required to be released from a high stack, which will have CAPEX cost. In addition, thermal and mechanical energy will also be related to handling the large volume of inert gas.

By using oxygen enriched gas, the plant volume may be reduced, but a lower limit exists in this respect, since the SO₂ oxidation process is exothermal and conventional SO₂ oxidation catalysts with stable operation above 650° C. have not been available. Therefore, a practical limit of 14% SO₂ has been common to stay under that temperature, which is operational with only moderate O₂ enrichment. To control the temperature in the SO₂ oxidation reactor, it has been proposed to recirculate an amount of cooled SO₃ rich product gas, to function as a combined heat sink and reaction moderator, which may enable operation at 25 vol % SO₂. The temperature may also be moderated by staged addition of O₂. In addition, the reactor temperature is commonly controlled by cooling between beds of catalytically active material. This has the effect of withdrawing thermal energy to other processes, of protecting catalytically active material against excessive temperature peaks and of pushing the reaction towards additional conversion, as the SO₂/SO₃ equilibrium favors SO₃ at lower temperatures.

As an alternative we have now identified that a material catalytically active in SO₂ oxidation which may operate up to 750° C., also enables operation with 35 vol % SO₂ or even higher SO₂ concentrations with minor process modifications, as this would release an amount of thermal energy corresponding to this temperature. We have developed one such material catalytically active in oxidation of SO₂ to SO₃ and stable at elevated temperature comprising vanadium pentoxide (V₂O₅), sulfur in the form of sulfate, pyrosulfate, tri- or tetrasulfate, one or more alkali metals on a porous carrier comprising at least 25 wt % crystalline silica or 50 wt % crystalline silica. Such a material catalytically active in SO₂ oxidation at high temperature may be used in one bed or in multiple beds depending on the specific process conditions. In addition other, low temperature beds may operate with a standard material catalytically active in oxidation of SO₂ to SO₃ such as a catalyst comprising vanadium pentoxide (V₂O₅), sulfur in the form of sulfate, pyrosulfate, tri- or tetrasulfate, one or more alkali metals on a porous carrier comprising at least silica in the form of diatomaceous earth—which provides a higher surface area—and thus activity compared to the catalytically active material comprising the more stable crystalline silica. In active use the V₂O₅ on the SO₂ oxidation catalyst is in the form of a vanadium sulfate melt. Furthermore, noble metal based catalytically active materials are also known for use in the oxidation of SO₂ to SO₃, and while these may be partially deactivated at elevated temperatures, they may have sufficient activity for the initial conversion.

Such operation with 35 vol % SO₂ may either be carried out by continuous admission of an amount of N₂ or by recirculation of SO₃ product or N₂. Oxygen enriched gas may be provided, either from the outlet from electrolysis producing hydrogen from water and electricity, or from an air separation unit. Electrolysis will provide close to 100% O₂, and an air separation unit may provide from 90% to 99.5% pure O₂. If an amount of desulfurized process gas is recycled, an amount of inert process gas may build up, but may be minimized by releasing a minor amount as purge, which may be treated by scrubbing or other conventional methods. Assuming combined use of O₂ enriched air and purge, such that the amount of N₂ and O₂ are equal, the process gas volume, and thus equipment size, may be reduced by more than a factor of 2. In addition, the recycling of product gas may also mean that such a process plant may be pressurized, since the release to the atmosphere of only a minimal amount of gas will also minimize the energy lost in pressurization. A pressure around 10 barg, will result in a factor 10 reduction of size of process equipment, but depending on the choice of material, higher pressure and increased reduction of size may be possible, but practical construction of equipment may limit the pressure to below 50 barg or 100 barg, which is required for compatibility with processes for production of methanol and ammonia. In total the volume of many parts of the plant may be reduced by a factor 20 by operation with pure O₂ and a pressure of 10 barg. In theory, the process may operate with only release of sulfuric acid and no release of flue gas, but as mentioned, in practice a small purge may be required to withdraw impurities such as nitrogen and carbon dioxide inter alia originating from the combustion of sulfur, with an amount of impurities.

The operation at elevated temperature will mean that the temperature and/or pressure of steam collected is increased, to the benefit of the locations where steam is used. In addition, the lower process plant size and the lower amount of flue gas released (if any) will also mean that the thermal efficiency of the process is increased.

The recycle of the process gas leaving the absorber also has the benefit that the absorption does not need to be 100% quantitative, and thus only a single absorber is required.

As no water enters the process, the absorber with recirculating acid will require an addition of water to hydrate the sulfur trioxide to form sulfuric acid.

The process may also be configured for addition of water up to or slightly above a ratio of water and SO₃ of 1:1, and condensation of an amount of the resulting sulfuric acid, prior to the absorption of SO₃ in lean sulfuric acid. This has the benefit of enabling withdrawing heat of condensation and hydration separately from the absorption process, such that temperature control in the absorber is simplified.

The process plant for production of sulfuric acid will often be positioned in a factory for production of fertilizer, since the phosphate used in fertilizer is commonly produced by dissolving phosphate rock by use of sulfuric acid. In addition to phosphate, ammonium is a common constituent in fertilizer, which is produced from ammonia.

Ammonia production is carried out catalytically at elevated temperature from atmospheric nitrogen and hydrogen. Traditionally the hydrogen has been produced from fossil sources, but an alternative will be to produce sustainable hydrogen electrolytically from water and a sustainable source of electricity and will in addition to hydrogen provide oxygen. In addition, as nitrogen is produced by separation of air in oxygen and nitrogen, excess oxygen is available from an ammonia plant, which conveniently may be employed in a sulfuric acid plant as described above. Furthermore, the heat released in the exothermal sulfuric acid process may be transferred to the ammonia plant, operating at about 850° C., and if energy efficient solid oxide electrolyzers are used they will also conveniently be able to employ thermal energy to ensure operation at elevated temperature.

Furthermore, other hydrogen consuming processes may be relevant sources of pure oxygen—including methanol synthesis and synthetic fuel produced either from methanol or by the Fischer Tropsch process, as well as refineries hydrogenating renewable feedstocks with electrolytically produced hydrogen.

### FIGURES

FIG. 1 illustrates a sulfuric acid plant according to the present disclosure.

FIG. 2 illustrates a sulfuric acid plant according to the prior art.

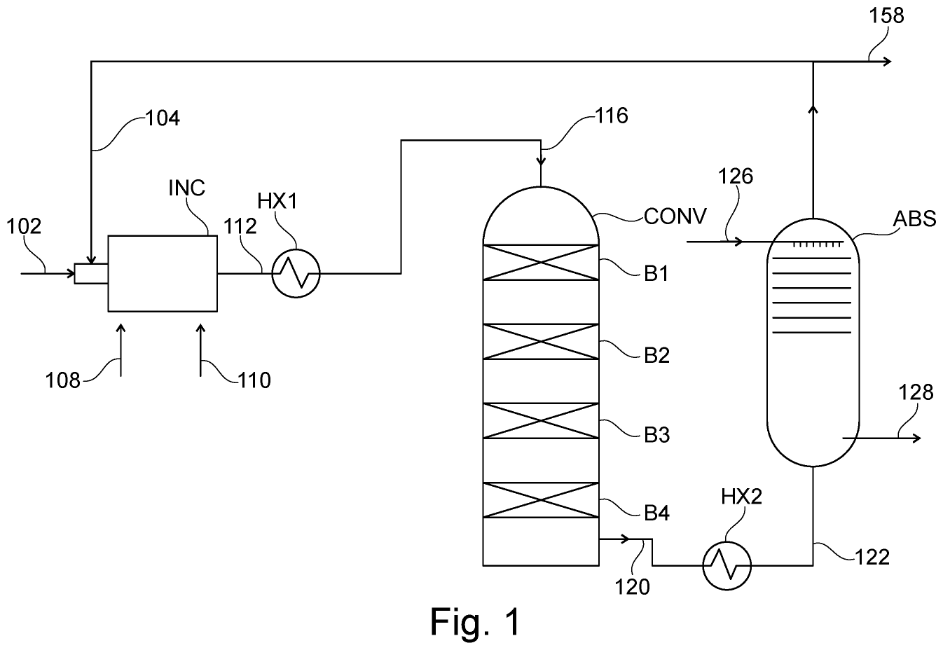

In FIG. 1, a process according to the present disclosure is shown. A stream of elemental sulfur (102) and a recycle stream (104) are directed to an incinerator (INC) also receiving an O₂ enriched stream (108) and optionally also atmospheric air (110). The hot incinerated process gas (112) is cooled in a heat exchanger (HX1) which may be a waste heat boiler, connected to a steam circuit (not shown). The resulting process gas comprising SO₂ (116) is directed to an SO₂ converter (CONV), containing 4 beds of catalytically active material (B1-B4), with interbed cooling (not shown). The first bed (B1) and optionally the second bed (B2) will contain a heat stable SO₂ oxidation catalyst, comprising V₂O₅ and at least partially crystalline silica, such as the proprietors product VK-HT. The following beds (B3 and B4) will contain regular SO₂ oxidation catalyst, comprising V₂O₅ and a high surface non-crystalline silica, e.g. diatomaceous earth, such as the proprietors VK-38, VK-48 and VK-59. The oxidized process gas (120) is directed to cooling in a heat exchanger (HX2), and the cooled oxidized process gas (122) is directed to a sulfuric acid absorber tower (ABS), receiving weak sulfuric acid (126) and providing concentrated sulfuric acid (128). The desulfurized process gas is directed as recycle stream (104), optionally after withdrawal of amount of gas as purge (158).

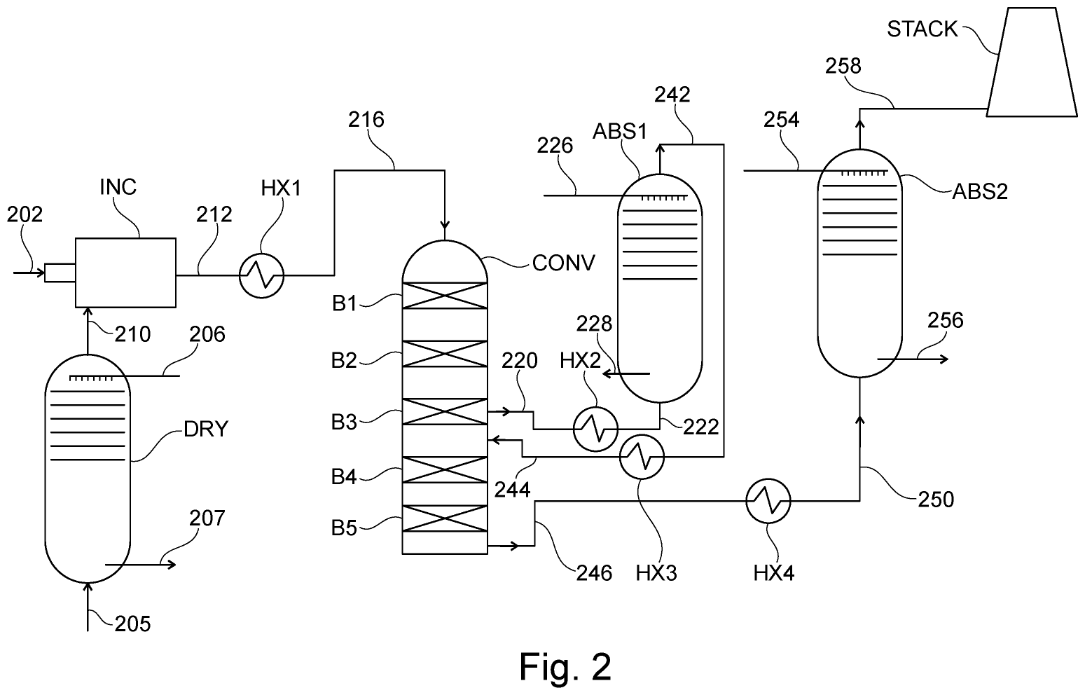

In FIG. 2, a process according to the prior art is shown. Dried air is provided by directing a stream of atmospheric air (205) to a drying column (DRY) receiving concentrated sulfuric acid (206) and providing a weaker sulfuric acid (207) having captured water in the atmospheric air (205) to provide a stream of dried atmospheric air (210) which is combined with a stream of elemental sulfur (202) are directed to an incinerator (INC). The hot incinerated process gas (212) is cooled in a heat exchanger (HX1) which may be a waste heat boiler, connected to a steam circuit (not shown). The resulting process gas comprising SO₂ (216) is directed to an SO₂ converter (CONV), containing 5 beds of catalytically active material (B1-B5), with interbed cooling (not shown). The first three beds (B1-B3) constitute a first stage and contains regular SO₂ oxidation catalyst, comprising V₂O₅ and at non-crystalline silica, e.g. diatomaceous earth, such as the proprietors VK-38, VK-48 and VK-59, and provides a first stage oxidized process gas (220). The first stage oxidized process gas (220) is directed to cooling in a heat exchanger (HX2), and the cooled oxidized process gas (222) is directed to a first sulfuric acid absorber tower (ABS1), receiving weak sulfuric acid (226) and providing concentrated sulfuric acid (228). The first stage desulfurized process gas (242) is directed as feed stream (244) for the second stage, constituted by bed 4 (B4) and bed 5 (B5). The final oxidized process gas (246) is cooled (HX4) and directed to a second sulfuric acid absorber tower (ABS2), receiving weak sulfuric acid (254) and providing concentrated sulfuric acid (256). The final desulfurized process gas (258) is directed to be released to the environment via a stack (STACK).

### EXAMPLES

Two examples are presented, for comparison of traditional operation with operation according to the present disclosure.

In both examples 27 t/h sulfur is directed to the process which provides 83 t/h sulfuric acid.

Table 1 shows an example corresponding to FIG. 1, according to the present disclosure. This example assumes that 100% pure oxygen is used for incineration and SO₂ oxidation, and that SO₂ oxidation is carried out in 4 beds, of which 2 have a temperatures of 740° C. and 640° C., thus exceeding the common limit around 630° C. Concentrations are shown with reference to Figure captions (with B1,B2,B3 and B4 referring to the outlet of the beds of catalytically active material) in volume %, and total gas flows in Nm³/h, and the flow of sulfur in t/h.

According to the example a purge is not carried out, but a presence of nitrogen is assumed. If the oxygen source is air separation, the oxygen enriched gas may comprise an amount of nitrogen, which increases with recycle. In this case a small purge is necessary. In practice the place of the nitrogen may be taken by recycled SO₃, but for computational convenience a presence of nitrogen as diluent is assumed.

Depending on the impurities (which in addition to nitrogen, also may include CO₂ and H₂O from combustion of hydrocarbon impurities in the sulfur) of a small purge may be required. Assuming an impurity corresponding to 7% of the O₂, the purge will be 3270 Nm³/h (12% of the recycle), and assuming 0.5%, the purge will be 234 Nm³/h (0.85% of the recycle), which is 40 Nm³/t sulfuric acid and 2.8 Nm³/t sulfuric acid respectively. The purged stream must be purified by scrubbing or other means, as it will contain some SO₂ and SO₃.

The total amount of catalyst is 206 m³, and due to the temperature the catalyst of beds 1 and 2 is of the type V₂O₅ sulfate on crystalline silica whereas the rest is V₂O₅ sulfate on diatomaceous earth.

The process pressure is 10 bar, and thus the volume of the incinerator, heat exchangers and the absorber may be reduced, but a pressure shell must be provided.

For comparison, Table 2 shows an example corresponding to FIG. 2, according to the prior art. This example assumes that atmospheric air is used for incineration and SO₂ oxidation, and that SO₂ oxidation is carried out in a so-called 3+2 dual converter and dual absorber (DCDA) configuration, with 3 beds in the first converter and 2 beds in the second. None of the beds exceed the common limit of 630° C. Concentrations are shown with reference to Figure captions (with B1,B2,B3, B4 and B5) referring to the outlet of the beds of catalytically active material) in vo Western Australia,
lume %, and total gas flows in Nm³/h, and the flow of sulfur in t/h.

The total amount of catalyst is 405 m³, and all catalyst is of the type of V₂O₅ on non-crystalline silica, such as diatomaceous earth.

The process pressure is 1.3 bar, and thus the need for a pressure shell is avoided. The volume of purified process gas released to the environment is 137,217 Nm³/h, which is 1658 Nm³/t sulfuric acid.

When comparing the two examples, the use of a heat stable catalytically active material enables use of pure oxygen as oxidant. The result is a reduction of catalyst volume to almost half, due to a combination of increased reaction rate due to increased temperature, increased SO₂ partial pressure and an acceptable lower conversion, due to the recycle. Furthermore, the use of pure oxygen reduces the volume of process gas released to the environment by 99.8%, which also is relevant for the size of the stack used in the plant.

As the temperatures of the process with pure oxygen are higher, the value of heat integration to other plants will also increase. This will be beneficial for ammonia production or methanol, and generally if the pure oxygen is obtained from a process plant, where hydrogen is produced electrolytically by high temperature electrolysis in a solid oxide electrolyzer.

TABLE 1

| | 102 | 108 | 116 | B1 | B2 | B3 | B4 | 104 | 158 |
|---|---|---|---|---|---|---|---|---|---|
| Temperature | | | 380° C. | 740° C. | 640° C. | 560° C. | 480° C. | | |
| S | 100% | | | | | | | | |
| O₂ | | 99.5% | 35% | 30% | 26% | 23% | 22% | 35% | 35% |
| SO₂ | | 0% | 35% | 21% | 11% | 5% | 1% | 2% | 2% |
| SO₃ | | 0% | 0% | 17% | 29% | 37% | 41% | 4% | 4% |
| N₂ | | 0.5% | 30% | 33% | 34% | 36% | 36% | 59% | 59% |
| Total flow | 26.97 | 28,377 | 56,127 | 51,760 | 49,087 | 47,396 | 46,605 | 28,660 | 234 |
| | [t/h] | [Nm³/h] | [Nm³/h] | [Nm³/h] | [Nm³/h] | [Nm³/h] | [Nm³/h] | [Nm³/h] | [Nm³/h] |

TABLE 2

| | 202 | 210 | 216 | B1 | B2 | B3 | 242 | B4 | B5 | 258 |
|---|---|---|---|---|---|---|---|---|---|---|
| Temperature | | | 425° C. | 620° C. | 520° C. | 470° C. | | 430° C. | 380° C. | |
| S | 100% | | | | | | | | | |
| O₂ | | 21% | 9% | 6% | 5% | 4% | 5% | 4% | 4% | 4% |
| SO₂ | | 0% | 12% | 5% | 2% | 1% | 1% | 0% | 0% | 0% |
| SO₃ | | 0% | 0% | 7% | 10% | 11% | 0% | 1% | 0% | 0% |
| N₂ | | 79% | 79% | 82% | 83% | 84% | 94% | 95% | 95% | 95% |
| Total flow | 27.25 | 165,670 | 165,670 | 159,764 | 157,454 | 156,692 | 138,756 | 138,224 | 137,217 | 137,217 |
| | [t/h] | [Nm³/h] | [Nm³/h] | [Nm³/h] | [Nm³/h] | [Nm³/h] | [Nm³/h] | [Nm³/h] | [Nm³/h] | [Nm³/h] |

1. A process for conversion of SO₂ to H₂SO₄ comprising the steps of
a. directing a process gas stream comprising at least 15 vol % SO₂, and an amount of O₂ originating from a source of purified O₂ or O₂ enriched air to contact a first material catalytically active in oxidation of SO₂ to SO₃ under oxidation conditions involving a maximum steady state temperature of the catalytically active material above 700° C., to provide an oxidized process gas stream, wherein said material catalytically active in oxidation of SO₂ to SO₃ comprises an active phase in which the weight ration of vanadium to other metals is at least 2:1 supported on a porous carrier comprising at least 25 wt % crystalline silica,
b. absorbing at least an amount of the produced SO₃ in a stream of lean sulfuric acid to provide a stream of liquid sulfuric acid and optionally a desulfurized process gas stream.

2. A process according to claim 1, further comprising the step of recycling an amount of oxidized process gas or desulfurized process gas to contact said first material catalytically active in oxidation of SO₂ to SO₃.

3. A process according to claim 1, wherein oxidation conditions involve a pressure above 2 Barg.

4. A process according to claim 1, wherein oxidation conditions involve a pressure below 100 Barg.

5. A process according to claim 1, wherein less than 100 Nm³ process gas per ton sulfuric acid produced is released to the atmosphere.

6. A process according to claim 1, wherein the first material catalytically active in oxidation of SO₂ to SO₃ comprises vanadium pentoxide (V₂O₅), sulfur in the form of sulfate, pyrosulfate, tri- or tetrasulfate, one or more alkali metals on a porous carrier comprising at least 50 wt % crystalline silica.

7. A process according to claim 1, wherein an amount of the process gas stream is provided from an O₂ enriched gas stream comprising at least 50 vol % O₂.

8. A process according to claim 1, further comprising the step of directing an amount of elemental sulfur and the O₂ enriched gas stream to a sulfur incinerator, to provide said process gas comprising SO₂.

9. A process according to claim 1, wherein at least an amount of the O₂ enriched gas stream is provided by electrolysis of H₂O.

10. A process according to claim 9 wherein electrolysis of H₂O is carried out in a process at a temperature above 400° C.

11. A process according to claim 1, wherein said process gas stream comprising at least 15 vol % SO₂, originates from incineration of sulfur or sulfur recuperation from smelter operation.

12. A process according to claim 1, wherein an amount of the O2 is provided by separation of atmospheric air.

13. A process for co-production of NH₃ and H₂SO₄ involving a process for production of H₂SO₄ according to claim 12, where the separation of atmospheric air further provides an N₂ enriched gas stream which is directed to a plant for production of NH₃, said process optionally involving the production of ammonium sulfate from NH₃ and H₂SO₄.

14. A process according to claim 13, wherein heat is released during oxidation of SO₂ to SO₃ and directed to be used in NH₃ production.

15. A process for production of fertilizer comprising ammonium and phosphate, comprising a process for co-production of NH₃ and H₂SO₄ according to claim 13 and the process of producing phosphate from a phosphor source, employing the produced H₂SO₄.

16. A process plant for production of H₂SO₄ comprising a means for production of an O₂ enriched stream having an O₂ enriched stream outlet, an optional sulfur incinerator having at least one inlet and an outlet, a reactor containing a material catalytically active in SO₂ oxidation at temperatures above 700° C. having an inlet and an outlet in fluid communication with the gas inlet of an absorber, having a liquid inlet for lean sulfuric acid, a liquid outlet for withdrawal of concentrated sulfuric acid and a gas outlet, wherein the O₂ enriched stream outlet is in fluid communication with the inlet of the reactor, or if the optional sulfur incinerator is present, with an inlet to the sulfur incinerator, having the outlet in fluid communication with the inlet of the reactor.
